(19) United States
(12) Patent Application Publication
(10) Pub. No.: US 2009/0094977 A1
(43) Pub. Date: Apr. 16, 2009

(54) Linear free piston stirling machine

(75) Inventor: Andrew Nicholas Hill, Peterborough (GB)

Correspondence Address: Ballard Spahr Andrews & Ingersoll, LLP, SUITE 1000, 999 PEACHTREE STREET, ATLANTA, GA, 30309-3915, US

(73) Assignee: MICROGEN ENERGY LIMITED, READING (GB)

(21) Appl. No.: 11/659,177

(22) PCT Filed: Aug. 4, 2005
(86) PCT No.: PCT/GB2005/003066

§ 371 Date: Sep. 16, 2008

(30) Foreign Application Priority Data
Aug. 6, 2004 (GB) 0417611.1

(51) Int. Cl. F02G 1/043; F02G 1/053; F16F 1/32

(52) U.S. Cl. 60/520; 62/6; 267/154

(57) ABSTRACT

A linear free piston Stirling machine having a displacer piston mounted on first and second planar springs. The first spring has a stiffness which increases with increasing spring displacement. The second has a stiffness which is less variable with spring displacement to provide a combined stiffness which rapidly increases once the displacer piston displacement exceeds a fixed limit. Each of the springs has a plurality of spiral spring portions and a stress relieving hole beyond the outer edge of the spiral spring portions.

The present invention relates to a linear free piston Stirling machine, such as an engine or cooler.

A linear free piston Stirling engine typically comprises a displacer piston and a power piston each of which reciprocates independently within the engine as is well known in the art.

In one construction, the displacer piston has a flexible rod which extends through the power piston and is then mounted on a pair of plate springs. The displacer piston mass and spring stiffness coupled by the flexible rod cause the displacer piston to move up and down at resonance.

In order to avoid collision noise and overstressing of the planar springs, it is necessary to maintain the amplitude of reciprocation of the displacer piston within certain physical limits of the design.

A number of ways have been proposed to overcome this problem including the use of spring magnets on the power piston to prevent over-stroking as shown in U.S. Pat. No. 4,937,481. However, these spring magnets produce fringing fields which interact with the magnetic flux from the main magnets and reduce the engine efficiency.

The present invention is directed to providing an alternative method of preventing over-stroking.

According to the present invention there is provided a linear free piston Stirling machine comprising a displacer piston and a power piston, the displacer piston being reciprocally mounted on first and second planar springs, wherein the first spring has a stiffness which increases with increasing spring displacement and the second piston has a stiffness which, in relation to the first spring, is less variable with a spring displacement.

By configuring the springs in this way, the combined response of the springs is such that, within the normal operating range of the engine, the second spring influences the displacer piston to a relatively greater degree, while the first spring has a relatively greater influence outside of the normal operating range. Thus, the pair of springs can be designed to fully satisfy the requirement to have a specific resonance stiffness during normal operating conditions which reduces the energy wasted, and a higher stiffness as the stroke limit is reached. This would be difficult and costly to achieve using two identical springs.

Preferably each planar spring has a plurality of spiral spring portions and a stress relieving hole positioned beyond the outer end of each spiral spring portion. This hole is positioned in the load path in the radially outer ring portion of the planar spring.

Preferably each stress relieving hole is sized and positioned to provide the required stiffness characteristics.

This feature forms a second aspect of the present invention which is broadly defined as a linear free piston Stirling machine comprising a displacer piston and a power piston, the displacer piston being reciprocally mounted on first and second planar springs, wherein at least one of the springs has a plurality of spiral spring portions and a stress relieving hole positioned beyond the outer end of each spiral spring portion. This invention may be used independently of or in conjunction with the first aspect of the invention.

An example of a linear free piston Stirling machine in accordance with the present invention will now be described with reference to the accompanying drawings, in which:

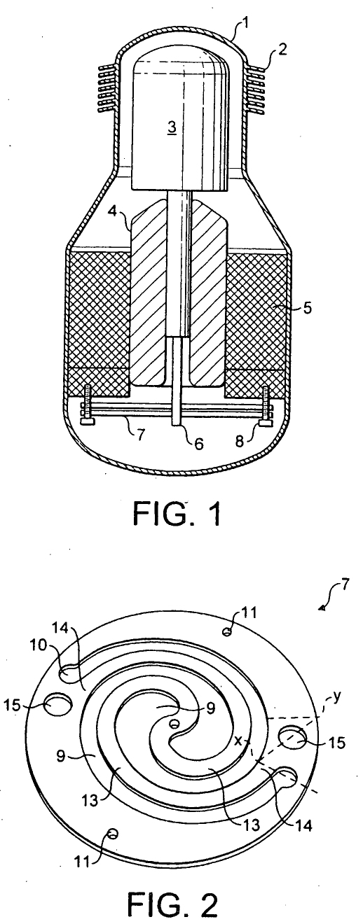

FIG. 1 is a schematic cross section showing a Stirling engine;

FIG. 2 is a perspective view of one of the springs;

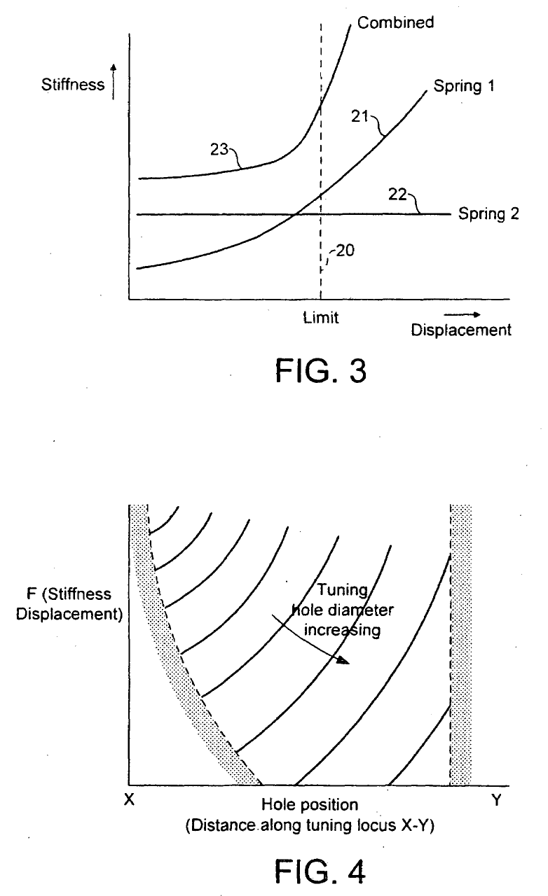

FIG. 3 is a graph showing the variation of the stiffness of the springs with displacement; and

FIG. 4 is a graph showing the variation in spring stiffness for hole position with different hole diameters.

A linear free piston Stirling engine is shown schematically in FIG. 1. The basic design of the engine is well known in the art (for example see page 9, FIG. 2, “Free-Piston Stirling Design Features”, Lane, N. W. and Beale, W. T.; 1997 [Review of current design features of free-piston Stirling engines of 3.0 and 1.1 kW output.], available at www.Sunpower.com/technology. Presented at the Eight International Stirling Engine Conference, May 27-3oth 1997, University of Ancona, Italy).

In simple terms, the engine has a head 1 having fins 2 which are heated by a burner (not shown). Within the engine housing, are a displacer piston 3 and a power piston 4 which reciprocate relatively to one another. The power piston 4 cooperates with an alternator 5 to generate electrical power.

The displacer piston 3 has a flexible rod 6 which extends through the centre of the power piston 4, which is mounted on a pair of planar springs 7. These are bolted by bolts 8 to the engine housing. As the displacer piston 3 reciprocates the planar springs 7 flex thereby creating a restoring force on the displacer piston to return it to its equilibrium position.

The design of one of the springs 7 is shown in greater detail in FIG. 2. As can be seen, the spring 7 has a flat circular configuration and can be stamped from sheet metal, polished, drilled and tempered. The spring has a pair of spiral cut-outs 9 which are symmetrical about an axis. Each of the spiral cut-outs 9 terminates at its radially outermost end with a radiused cut-out 10. A pair of mounting holes 11 are provided on opposite sides of the spring to receive the bolts 8. A central hole 12 receives the flexible rod 6 of the displacer piston 3.

The spiral cut-outs 9 form a pair of spiral spring portions 13. These have a generally constant cross-section, but become slightly wider at their radially outermost portions 14. Beyond the end of the spiral spring portions 13 are stress relieving holes 15.

The combination of the increased cross-section 14 of the radially outermost portions of the spiral spring portions and the stress relieving holes 15 provides a spring design with increased reliability. Effectively, the stress relieving holes 15 serve to minimise the peak stresses at the radially outermost end of the spiral spring portions 13 and transfer these stresses more smoothly across the remainder of the spring material radially outwardly of the spiral spring portions.

The characteristics of the spring in terms of its stiffness for a given displacement can be varied simply by changing the size of the stress relieving hole or its precise position with respect to the outer extremity of the spiral spring portion.

The two springs 7 are designed to have different stiffness characteristics for variations in displacement as shown in FIG. 3. Line 20 indicates the upper limit of desired displacement for the displacer piston 3. Below this limit, it is desirable to keep the stiffness of the spring pair at a constant level which is just sufficient to provide the required restoring force. Above this limit, it is desired to raise the stiffness as quickly as is practical in order to prevent over-travel of the displacer.

As can be seen from FIG. 3, the first spring has a stiffness designated by line 21 which is initially low at low displacement, but which rises, initially slowly towards the limit 20. The rise becomes steeper towards the limit 20, and then steeper again beyond the limit. By contrast, the second spring stiffness, designated by line 22, remains substantially constant for all displacements. The stiffness of the second spring initially starts out greater than the stiffness of the first spring, but the stiffness of the first spring exceeds the stiffness of the second spring at around the limit.

The combined stiffness of the two springs is shown in FIG. 3 as line 23. It can be seen that, below the limit, and for the normal range of travel of the displacer piston 3, the stiffness is generally constant, although increases slightly. Towards the end of the limit the stiffness begins to rise sharply, and this carries on beyond the limit. Effectively, the combined stiffness is dominated in the lower displacement region by the second spring and in the higher displacement regions by the first spring.

It should be appreciated that the combined characteristic may be achieved by combinations of springs different from those shown in FIG. 3. Thus, for example, although a second spring is shown substantially constant, it could also increase gradually, while the response of the first spring could be adjusted accordingly. With such an arrangement, it may not be necessary for the stiffness of the second spring to exceed the stiffness of the first spring in the regions of low displacement.

The position of the stress relieving holes is not something which is calculated but is rather determined by trial and error. A finite element analysis model was used so as to determine the position of the stress relieving holes which maintain as equal a stress distribution around the hole as possible. Original designs were modelled and found to have high stress concentrations across the inner end of the spring portions 13, and indeed this is where fractures occur during operation. The optimised design was obtained iteratively, using finite element analysis. FIG. 4 provides some indication of how the stiffness of the spring varies with the position and size of the hole. The hole position is defined with reference to a line extending from position X to position Y as shown in FIG. 2. It can be seen that as the hole is moved towards position Y, the spring stiffness increases. Also, the spring stiffness is seen to decrease with increasing hole diameter. The shaded areas on either side of the graph indicate the limit of this design as, when the hole diameter increases, it is clearly not possible to move fully from X to Y.

1. A linear free piston Stirling machine comprising a displacer piston and a power piston, the displacer piston being reciprocally mounted on first and second planar springs both of which exert a force on the displacer piston for its full range of movement, wherein the first spring has a stiffness which increases with increasing spring displacement and the second spring has a stiffness which, in relation to the first spring, is less variable with spring displacement.

2. A linear free piston Stirling machine according to claim 1, wherein each planar spring has a plurality of spiral spring portions and a stress relieving hole positioned beyond the outer end of each spiral spring portion.

3. A linear free piston Stirling machine according to claim 2, wherein the spiral spring portions increase in width towards their radially outermost end.

4. A linear free piston Stirling machine according to claim 2, wherein each stress relieving hole is sized to provide the required stiffness characteristics.

5. A linear free piston Stirling machine comprising a displacer piston and a power piston, the displacer piston being reciprocally mounted on first and second planar springs, wherein at least one of the springs has a plurality of spiral spring portions and a stress relieving hole positioned beyond and spaced from the outer end of each spiral spring portion.

6. A linear free piston Stirling machine according to claim 5, wherein the spiral spring portions increase in width towards their radially outermost end.
